(19) United States
(12) Patent Application Publication
(10) Pub. No.: US 2004/0103846 A1
(43) Pub. Date: Jun. 3, 2004

(54) A CLEANING DEVICE

(75) Inventor: Renatus Ignatius Fransen, Vlaardingen (NL)

Correspondence Address: HOWREY SIMON ARNOLD & WHITE, CITYPOINT, ONE ROPEMAKER STREET, LONDON, EC2Y 9HS, GB

(73) Assignee: LELY ENTERPRISES AG, Zug (CH)

(21) Appl. No.: 10/604,066

(22) Filed: Jun. 25, 2003

(30) Foreign Application Priority Data
Jun. 25, 2002 (NL) 1020934

(51) Int. Cl. A01J 3/00; A01J 5/00

(52) U.S. Cl. 119/14.03

(57) ABSTRACT

A cleaning device for cleaning the exterior of at least a part of a milking parlour. The milking parlour comprises a milking robot and a base on which an animal to be milked can stand. The cleaning device is provided with a source of cleaning foam. A method of cleaning the exterior of at least a part of a milking parlour is also disclosed. The method comprises the step of applying a cleaning foam on at least said part of the milking parlour.

### CROSS REFERENCE TO RELATED APPLICATIONS

This application claims priority from Dutch patent application no. 1020934 filed 25 Jun. 2002, the contents of which are hereby incorporated by reference in their entirety.

### BACKGROUND OF INVENTION

1. Field of the Invention

The invention relates to the field of animal husbandry and more particularly to a cleaning device for cleaning the exterior of at least a part of a milking parlour, the milking parlour comprising a milking robot and a base on which an animal to be milked can stand. The invention also relates to a method of cleaning the exterior of a milking parlour.

2. Description of the Related Art

A cleaning device is known in the form of a hose that is manually operated by a farmer and through which cleaning liquid is squirted. This operation of the cleaning device is time-consuming and cumbersome. As a result thereof it may sometimes happen that a farmer has insufficient time for cleaning the milking parlour, which may have a negative effect on the hygienic conditions. Hosing down of milking parlour using water or other liquid cleaners has a limited cleaning effect.

### SUMMARY OF INVENTION

According to the present invention there is provided a milking parlour comprising a base on which the animal to be milked can stand, a milking robot, and a cleaning device for cleaning an exterior of at least a part of the milking parlour, the cleaning device comprising a source of cleaning foam. Use of such cleaning foam ensures extremely hygienic cleaning of the milking parlour.

The cleaning device is preferably an automatic cleaning device.

Improved cleaning is obtained if the cleaning device comprises an element for bringing the cleaning foam under pressure, such as for example a pump.

The cleaning device preferably comprises a nozzle that is disposed in a fixed position relative to the milking parlour. For obtaining a desired cleaning, it may in some cases be desirable to use several nozzles fixed in different places. The operation or control of the several nozzles can then be attuned to each other, for example by software control.

The entire milking parlour can be cleaned in a simple manner if the nozzle is movably disposed relative to the milking parlour. The nozzle may for example be fastened for movement along a rail.

Extremely efficient cleaning can be obtained if the nozzle is fastened to a robot arm. Such a robot arm may be equipped with a gripper for gripping the nozzle.

Although the nozzle may be rigidly suspended, for example in a fixed position relative to the robot arm, it is advantageous if the nozzle is movably suspended. This makes it possible to obtain a larger cleaning range.

There is preferably provided a contents-measuring device for measuring the contents of the source containing the cleaning foam. The contents-measuring device may be capable of emitting a control signal or an indication signal for automatic control of interchanging the source for a new source or for giving an indication to a farmer, for example on a display, via a sound, or via the mobile telephone of the relevant farmer, or to a service department.

In order to ensure that the cleaning is performed at a suitable point of time, a preferred embodiment of a cleaning device according to the invention is provided with a presence-detecting device for detecting the presence of an animal in the milking parlour. The presence-detecting device, upon detection of an animal in the milking parlour, emits a signal to the cleaning device to stop or prevent the operation of the cleaning device.

For simplified cleaning only in cases of necessity, there may preferably be provided a cleanliness-detecting device for detecting the cleanliness of the milking parlour, the cleaning device being controlled with the aid of data from the cleanliness-detecting device. The cleanliness-detecting device may also be used for checking the effect of the foam cleaning, possibly including rinsing, and foam cleaning again, if desired, depending on the result of the check.

For preventing an animal from entering the milking parlour during cleaning, the cleaning device may comprise a closing element for closing the entrance to the milking parlour when the cleaning device is in operation.

The cleaning device preferably comprises a rinsing device for rinsing the exterior of the milking parlour after foam cleaning. As a result thereof the hygienic conditions of the milking parlour are further improved.

The cleaning device is preferably provided with an additive element for adding additives to the cleaning foam, so that for a specific cleaning a specific additive can be used, for example for dissolving or soaking particular impurities. In this context disinfecting means and the like may be taken into consideration. Adding additives preferably takes place automatically. For example, after a predetermined number of normal cleanings, a cleaning with a specific additive may be performed.

The invention also relates to a method of cleaning the exterior of at least a part of a milking parlour, the milking parlour comprising a milking robot and a base on which an animal to be milked can stand, wherein the method comprises applying a cleaning foam on at least that part of the milking parlour. The part cleaned is preferably the lower part of the milking robot.

### BRIEF DESCRIPTION OF DRAWINGS

An embodiment of the invention will now be explained in further detail by way of example only with reference to the accompanying drawings, in which:

FIG. 1 is a schematic side view of an embodiment of a cleaning device according to the invention;

FIG. 2 is a schematic side view of an alternative embodiment of a cleaning device according to the invention;

FIG. 3 is a schematic plan view of the embodiment according to FIG. 2;

FIG. 4 is a schematic plan view of a further alternative embodiment of a cleaning device according to the invention; and

FIG. 5 is a schematic plan view of another further alternative embodiment of a cleaning device according to the invention.

### DETAILED DESCRIPTION

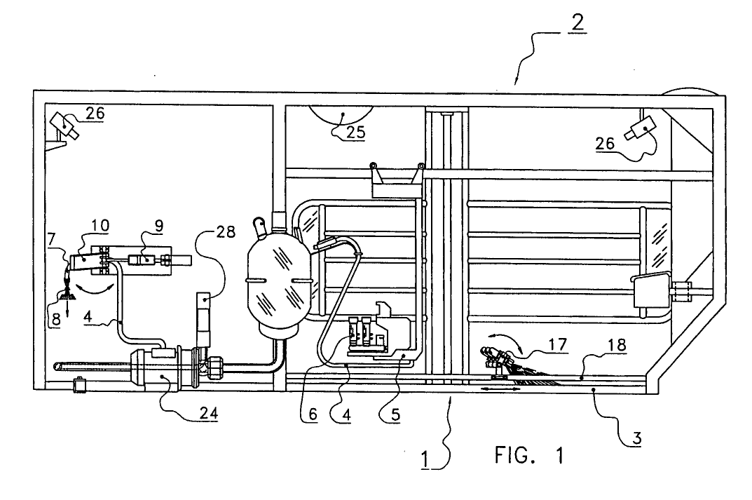

FIG. 1 is a schematic side view of a milking parlour 1. The milking parlour 1 comprises inter alia a milking robot 2 and a base 3 on which an animal to be milked can stand. The milking robot 2 is provided with a rinsing device 4 for cleaning the interior of the milking robot 2 by means of rinsing liquid. The rinsing device 4 rinses and cleans in particular the components of the milking robot 2 that come into contact with milk, such as milk lines and the like. The milking robot 2 further comprises a robot arm 5 for carrying inter alia teat cups 6.

The invention relates to a cleaning device, in particular an automatic cleaning device, for cleaning the exterior of the milking parlour 1 by means of a cleaning foam. A few embodiments of such an automatic cleaning device will be described hereinafter. In the embodiments shown in the figures, reference numeral 28 indicates a source of cleaning foam, which cleaning foam is pumped under pressure, for example by means of a pump 24 and the line 4, to the nozzle 8, where the foam is applied over at least a part of the milking parlour, in particular the lower part of the milking robot.

The cleaning foam may be any commercially available foam suitable for cleaning of dairy installations. Such foams may be particularly adapted to prolong contact time with surfaces to be cleaned, thereby increasing their cleaning or disinfecting effect. While reference is made in the present description to cleaning foams, this should be understood to include products forming gels and similar formulations to enhance cleaning contact known to those of skill in the art.

FIG. 1 shows an embodiment in which it is possible to perform a rinsing-cleaning after the foam cleaning. In this case rinsing liquid coming from the milking robot 2 is used as rinsing liquid for the exterior of the milking parlour 1. Guide means 7 guide the rinsing liquid to a nozzle 8 constituting an outlet of the cleaning device. The guide means 7 and the nozzle 8 are disposed on a movable separation arm 10 driven by a cylinder 9.

The separation arm 10 is movable in a reciprocating manner by operating the cylinder 9, so that a larger surface of the exterior of the milking parlour 1 can be cleaned.

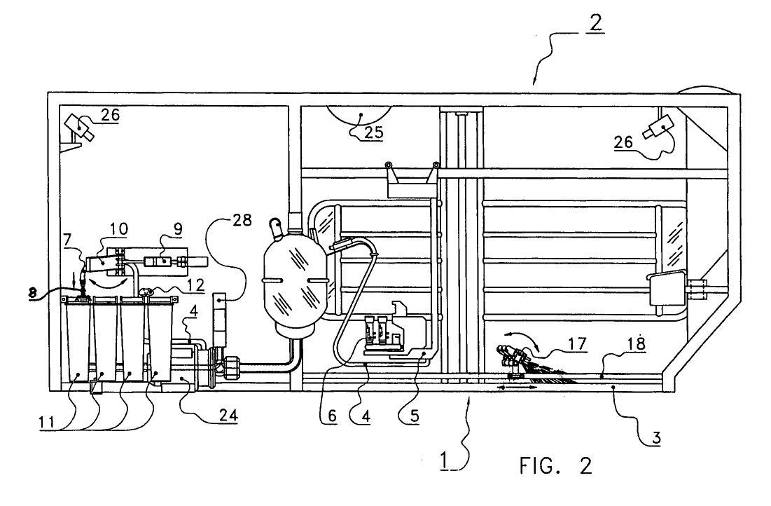

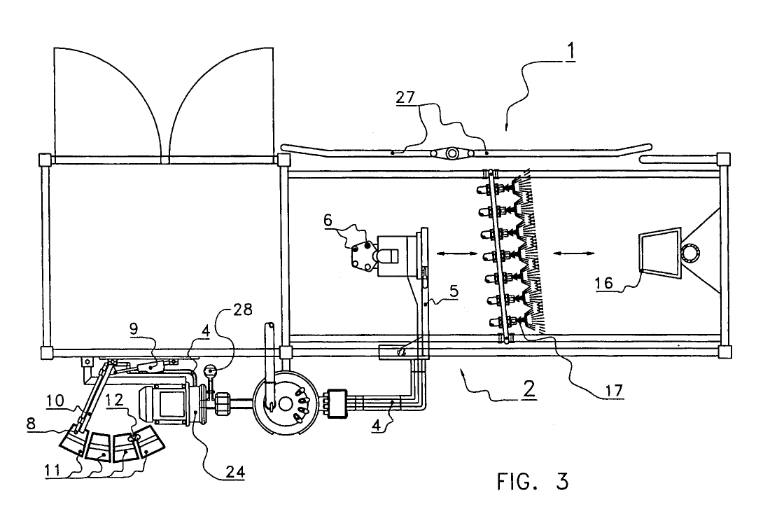

The milking parlour 1 may be provided with a number of containers 11 (see FIGS. 2 and 3), each suitable for containing a particular sort of used rinsing liquid. For the purpose of discharging particular rinsing liquids, the separation arm 10 can then be moved to above a relevant container 11 by automatic operation of the cylinder 9. There is thus provided a possibility of waste processing, and particular sorts of used rinsing liquid, such as a base, acid or chlorine solution, can be collected for being processed.

As shown in FIG. 2, the nozzle 8 is located at a small distance above the containers 11. For the purpose of ensuring in this embodiment that, besides the discharge of the rinsing liquid into the containers 11, the exterior of the milking parlour 1 is cleaned, the containers 11 may for example be designed to be movable. Alternatively there may also be provided a spreading plate 12, the nozzle 8 being movable to the spreading plate 12. The spreading plate 12 then ensures a spreading of the rinsing liquid or the cleaning foam over the exterior of the milking parlour 1. It will be obvious that the containers can alternatively also be automatically closable, and that the spreading plate can also be used differently than in combination with the containers.

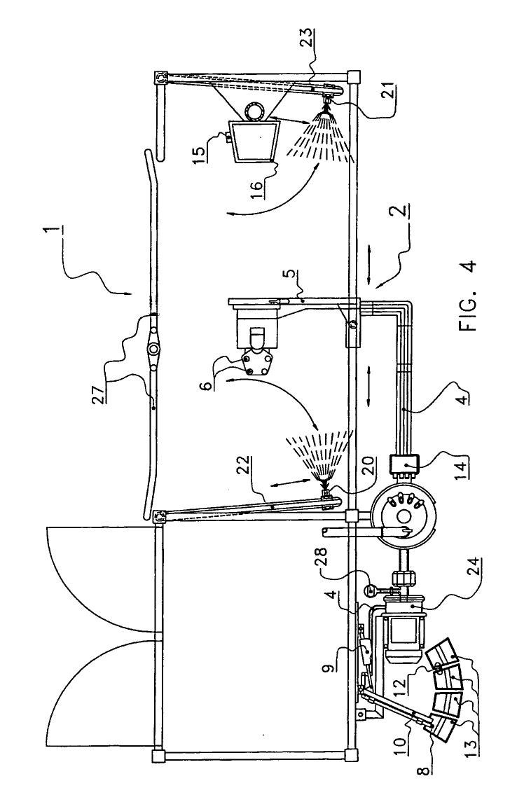

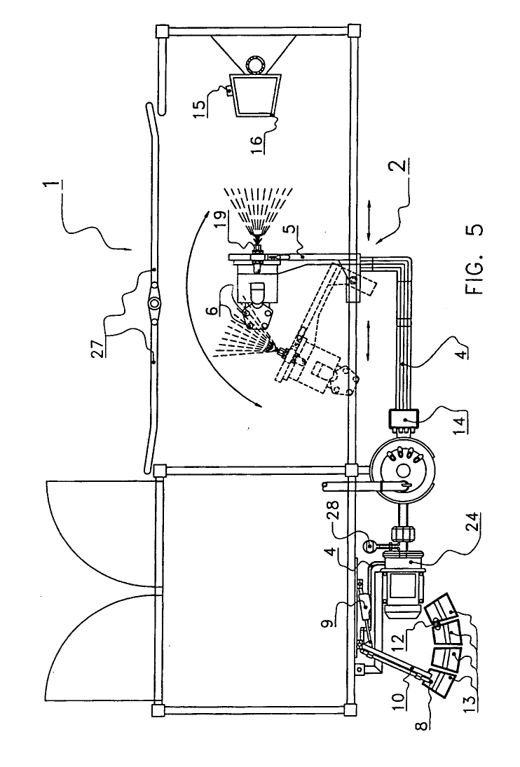

The milking parlour 1 is also provided with a number of containers 13 (see FIGS. 4 and 5), each suitable for containing a particular sort of milk obtained, such as colostrum, milk containing blood, antibiotics, or the like. These sorts of milk then flow to the outlet 8 via the milk lines 4 of the teat cups 6. By automatic operation of the separation arm 10 the sorts of milk can then be discharged into the relevant containers 13. In this manner the sort of milk obtained can be separated per animal, if desired, and is not collected in one sole container. The movement of the separation arm 10 may be controlled with the aid of determining device 14 for determining the sort of rinsing liquid or cleaning liquid used or the sort of milk obtained. In the case of the sort of milk obtained, the control of the separation arm is preferably partially realized with the aid of data from an animal identification device 15 that is disposed for example on a feeding trough 16.

There are preferably provided contents-measuring devices (not shown) for measuring the contents of the source 28 of cleaning foam and possibly of the containers 11, 13. The contents-measuring device can emit a control signal respectively an indication signal for automatic control of interchanging the source or the containers or for giving an indication to a farmer, for example on a display, via a sound, or via the mobile telephone of the relevant farmer, or to a service department. The contents-measuring device may for example be constituted by weighing means or means for determining the level of the liquid in the source and/or the containers.

According to the embodiment of FIG. 1, it is also possible, although not shown in the drawing, that the nozzle 8 is movable to above the inlet of a line, the line conveying the cleaning foam or the rinsing liquid to at least one nozzle 17. The nozzle 17 is movably disposed relative to the milking parlour 1. This movability may be obtained for example by fastening to a rail 18. The movement over the rail 18 is such that at least substantially the entire base 3 of the milking parlour 1 can be cleaned by the nozzle 17. For the purpose of increasing the cleaning range of the foam cleaning, each of the nozzles is preferably movably suspended. The movement may be a driven movement, but is preferably automatically controlled by the force of the jet of foam.

In addition to movable connection to a rail, a nozzle 19 may also be fastened to the robot arm 5, as shown in FIG. 5. By the movement of the robot arm 5, schematically shown by the pivotal movement of the position indicated by solid lines to the position indicated by broken lines, the entire base 3 of the milking parlour 1 can be covered. It is noted that, if the nozzle 19 is fastened movably rather than rigidly to the robot arm 5, other parts of the exterior of the milking parlour 1 can also be cleaned with foam or rinsed.

The nozzle 19 may be rigidly fastened to the robot arm 5, but the latter may also be equipped with a gripper for gripping the nozzle, so that the nozzle can be disposed in a storage element beside the milking robot and taken out therefrom by the gripper when required.

FIG. 4 shows further nozzles 20 and 21 for cleaning the exterior of the milking parlour 1. The nozzles 20, 21 may be rigidly or movably fastened to pivotable arms 22 respectively 23. The nozzles 20, 21 may alternatively be rigidly or movably fastened to non-movable parts of the frame of the milking robot 2 or other fixed components of the milking parlour 1.

Although the nozzles may be connected via lines to the outlet of the rinsing device for the interior of the milking robot, it is also possible for the nozzles to be coupled alternately to the source of foam or to a source of clean water, such as a water tap.

A pump 24 may be provided for pressurising the liquids. The pump 24 may be switched on automatically in case of cleaning.

In order to ensure that the cleaning is performed at a suitable point of time, there is provided a presence-detecting device 25 (FIGS. 1 and 2) for detecting the presence of an animal in the milking parlour 1 detection of the presence of an animal in the milking parlour 1, the presence-detecting device 25 emits a signal to the cleaning device, which signal stops or prevents the operation of the cleaning device.

For cleaning in a simple manner in cases of necessity, there is preferably provided a cleanliness-detecting device 26 (FIG. 1) for detecting the cleanliness of the milking parlour 1. The cleanliness-detecting device 26 may comprise for example cameras. These cameras may be disposed in a fixed place in the milking parlour 1, but may also be disposed for example on the robot arm 5. The cleaning device is then controlled with the aid of data from the cleanliness-detecting device 26.

In order to prevent an animal from entering the milking parlour during cleaning, the cleaning device comprises a closing element 27 for closing the entrance to the milking parlour 1 when the cleaning device is in operation.

The rinsing device 4 may comprise a heating element, for example a heat exchanger, for heating the cleaning foam or the rinsing liquid. The heat exchanger may then make use for example of the heat that is released during the cooling of the milk.

The device is provided with a cleaning-starting element, in particular comprising a heating-starting element, for example constituted by the computer that is customarily present if there is provided a milking robot. The element controls the start of the cleaning, in particular also the heating, by means of the foam or the liquid. The moment of starting the cleaning (in particular the heating) is situated preferably immediately after the receipt of an off-peak signal (described hereinafter), or within a particular period of time after the receipt of the off-peak signal. Such an off-peak signal is emitted by the computer of the cleaning-starting element on the basis of historical visit data in the memory of the computer. If an analysing/calculating element calculates, with the aid of such historical data, that an off-peak period is expected within a predetermined period of time, an off-peak signal is emitted.

A measuring element measures the temperature of the cleaning foam and emits a temperature signal to the heating-starting element. If the temperature signal indicates that a predetermined temperature value has been reached, the cleaning-starting element starts the actual cleaning. For this purpose the cleaning starting element is connected to the components of the device that are relevant for the cleaning.

The memory also provides a check of the cleaning, and comprises for this purpose heating data measured by the temperature-measuring element. The calculating element can further determine, on the basis of the heating data stored in the memory and the momentary temperature of the cleaning foam as measured by the measuring element, the remaining heating duration until the predetermined temperature value has been reached.

The device preferably operates as follows:

In the starting phase, the off-peak periods in the visits are manually inputted by the farmer, for example by means of a keyboard. The number of off-peak periods may be chosen by the farmer, but should from the point of view of hygiene amount to at least three.

The farmer may further input a period of time that will be situated between the expected beginning of an off-peak period and a previously to be emitted off-peak signal.

If, on the basis of the inputted data, an off-peak period will occur, first the off-peak signal is emitted. Said off-peak signal may ensure inter alia the activation of the heating element, so that the foam or the rinsing liquid is heated.

The detecting device detects whether or not an animal is present in the milking machine. If an animal is present, the cleaning device only starts the actual cleaning upon receipt of a signal from the detecting device indicating that the animal has left the milking parlour.

In order to achieve a more efficient use of the milking parlour and the cleaning device, an identification system known per se determines the identity of an animal that reports at the milking machine for being milked. On the basis of the identity, it is possible to obtain an expected milking duration of the animal, which milking duration is stored in a memory and is continuously updated, if desired. If the expected milking duration is longer than the remaining heating duration as determined with the aid of the measuring element and the calculating element, an entrance gate to the milking parlour remains closed when an animal reports.

Only if the expected milking duration is shorter than the remaining heating duration, the animal is still admitted to the milking parlour and can be milked, while at the same time the foam in the source of foam is heated.

If it is no longer possible to milk an animal, then, after the animal has left the milking parlour, the actual cleaning is started at the moment when the cleaning foam has reached the desired temperature. The desired temperature depends on the sort of cleaning process applied.

The data in the memory in relation to the visits to the milking machine are continuously updated in order to be able to take a changed visiting behaviour of the dairy animals into account.

In the cleaning process, the average cleaning duration (for example of the foam cleaning including the rinsing) is also taken into account. The off-peak periods in which the cleaning is performed are preferably the longest periods, so that the dairy animals experience little inconvenience as a result of the cleaning of the milking parlour. If there are more off-peak periods that are eligible for cleaning periods, other parameters may also determine the selection of those off-peak periods in which cleaning takes place. Preferably those off-peak periods are selected that coincide with periods in which energy costs are low (e.g. night-tariff supply).

In the case that certain components of the milking parlour can be cleaned or rinsed at a lower temperature, it is possible to ensure by proper control that these components are cleaned or rinsed at the moment of reaching that temperature.

It will be obvious that the invention is not limited to the above-described embodiments, but that all sorts of modifications are possible within the scope of the claims. There may be provided for example a drying device for drying the exterior of the milking parlour after rinsing. This is in particular advantageous if also the operation space of the milking robot has to be cleaned. There may further be provided an additive element for adding additives to the cleaning foam and/or the rinsing liquid, so that for a specific cleaning a specific additive can be used. In this respect, for example, dirt solvents, soaking means, disinfecting means and the like may be taken into consideration. Adding additives preferably takes place automatically. For example, each time after a predetermined number of normal cleanings, a cleaning with one of the specific additives may take place. The additive element may further be controlled with the aid of data from the animal identification device, so that it is possible to clean the milking parlour in a specific manner after a visit of a specific animal to the milking parlour. It will further be obvious that there is preferably provided a computer that controls the functions of the cleaning device on the basis of data obtained. Additionally there may be provided an activation switch for manually activating the cleaning device, the cleaning itself not requiring further actions. Although the invention has been described with reference to a rinsing device for cleaning the interior of the milking robot 2 by means of rinsing liquid, which rinsing device is also used for the foam cleaning and the rinsing-cleaning of the exterior of at least a part of the milking parlour, it is also possible, of course, to use separate devices for these different purposes.

Many modifications in addition to those described above may be made to the structures and techniques described herein without departing from the spirit and scope of the invention. Accordingly, although embodiments have been described, these are examples only and are not limiting upon the scope of the invention.

1. A milking parlour comprising:
a base on which the animal to be milked can stand;
a milking robot; and
a cleaning device for cleaning an exterior of at least a part of the milking parlour, the cleaning device comprising a source of cleaning foam.

2. The milking parlour as claimed in claim 1, wherein the cleaning device is an automatic cleaning device.

3. The milking parlour as claimed in claim 1, wherein the cleaning device comprises an element for placing the cleaning foam under pressure.

4. The milking parlour as claimed in claim 3, wherein the element comprises a pump.

5. The milking parlour as claimed in claim 1, wherein the cleaning device comprises a nozzle that is disposed in a fixed position relative to the milking parlour.

6. The milking parlour as claimed in claim 1, wherein the cleaning device comprises a nozzle that is movably disposed relative to the milking parlour.

7. The milking parlour as claimed in claim 6, wherein the nozzle is fastened to a rail.

8. The milking parlour as claimed in claim 6, wherein the nozzle is fastened to a robot arm.

9. The milking parlour as claimed in claim 1, wherein the cleaning device further comprises a contents-measuring device for measuring the contents of the source of cleaning foam.

10. The milking parlour as claimed in claim 9, wherein the contents-measuring device emits a control signal or an indication signal.

11. The milking parlour as claimed in claim 1, wherein the milking parlour further comprises a presence-detecting device for detecting the presence of an animal in the milking parlour, the presence-detecting device, upon detection of an animal in the milking parlour, emitting a signal to the cleaning device, which signal stops or prevents the operation of the cleaning device.

12. The milking parlour as claimed in claim 1, wherein the milking parlour further comprises a cleanliness-detecting device for detecting the cleanliness of the milking parlour, the cleaning device being controlled with the aid of data from the cleanliness-detecting device.

13. The milking parlour as claimed in claim 1, wherein the milking parlour further comprises a closing element for closing the entrance to the milking parlour when the cleaning device is in operation.

14. The milking parlour as claimed in claim 1, wherein the cleaning device comprises a rinsing device for rinsing the exterior of at least a part of the milking parlour after foam cleaning.

15. The milking parlour as claimed in claim 1, wherein the cleaning device comprises an additive element for adding additives to the cleaning foam.

16. The milking parlour as claimed in claim 1, wherein the milking parlour further comprises a cleaning-starting element for starting the cleaning.

17. The milking parlour as claimed in claim 16, wherein the milking parlour further comprises a computer comprising a memory, the computer storing points of time of visits of animals to the milking parlour in the memory, and wherein the cleaning-starting element is activated by a cleaning-starting signal emitted by the computer, on the basis of historical data stored in the memory in relation to the points of time of the visits of the animals.

18. The milking parlour as claimed in claim 17, wherein the milking parlour further comprises an identification system for determining the identity of animals and for detecting that animals are visiting the milking parlour, the computer storing the points of time of the visits of the animals in the memory with the aid of data from the identification system.

19. The milking parlour as claimed in claim 17, wherein the computer comprises an analysing unit for determining off-peak periods in the visits to the milking parlour.

20. The milking parlour as claimed in claim 17, wherein an average cleaning duration is stored in the memory of the computer.

21. The milking parlour as claimed in claim 20, wherein the computer comprises an analysing unit for determining off-peak periods in the visits to the milking parlour and, with the aid of the historical data, emits an off-peak signal indicating that an off-peak period is expected within a predetermined period.

22. The milking parlour as claimed in claim 21, wherein, on reaching the beginning of an off-peak period with an expected duration that is at least comparable with the average cleaning duration, the computer emits an activation signal for the cleaning-starting element.

23. The milking parlour as claimed in claim 17, wherein the computer activates the cleaning-starting element three times a day.

24. A method of cleaning the exterior of at least a part of a milking parlour, the milking parlour comprising a milking robot and a base on which an animal to be milked can stand, comprising:
providing an automatic cleaning device;
providing a source of cleaning foam for the automatic cleaning device; and
applying the cleaning foam to at least the part of the milking parlour by means of the automatic cleaning device.

25. The method as claimed in claim 24, wherein the cleaning foam is applied at least on the lower part of the milking robot.

26. The method as claimed in claim 24, further comprising determining off-peak periods in the visits by animals to the milking parlour, the cleaning of at least the part of the milking parlour taking place at least partially during an off-peak period.
